(19) United States
(12) Patent Application Publication
(10) Pub. No.: US 2005/0097520 A1
(43) Pub. Date: May 5, 2005

(54) Method for controlling of at least one component within a technical system and/or within a technical process and technical system

(76) Inventors: Ralf Wolters, Schonstett (DE); Robert Goldner, Munchen (DE)

Correspondence Address: KRIEGSMAN & KRIEGSMAN, 665 Franklin Street, Framingham, MA, 01702, US

(21) Appl. No.: 10/862,503

(22) Filed: Jun. 7, 2004

(30) Foreign Application Priority Data
Oct. 31, 2003 (DE) 103 51 019.2

(51) Int. Cl. G06F 9/44

(52) U.S. Cl. 717/134; 703/23

(57) ABSTRACT

Described is a process for controlling and/or regulating at least one component (11) in a technical system (10) and/or in a technical process. Further described is a corresponding technical system (10). The process is characterized in accordance with the invention by the following steps:
a) bundled in a computer operating environment (21) is a control program (22) for controlling and/or regulating at least one part of at least one component (11);
b) the control program (22) works together, in the computer operating system environment (21), with an emulation program (23), which simulates a computer environment with respect to the control program (22);
c) the emulation program (23) further simulates an interface (24) to a processing program (25), which generates, electronically, a suitable connection interface (26) between the control program (22) and the at least one component (11);
d) an exchange of data takes place unidirectionally or bidirectionally through the connection interface (26) between the control program (22) and the at least one component (11) for the purpose of control and/or regulation.

The present invention relates to a process for controlling and/or regulating at least one component in a technical system and/or in a technical process. Furthermore, the invention relates to a technical system.

Technical systems are characterized, as a rule, by the fact that they have diverse components. Technical processes proceed, as a rule, with the aid of at least one component. In the light of the present description, the term component is understood to refer to a structural element or component part of a technical system and/or a structural element or component part by the aid of which a technical process proceeds. The components can also be quite spatially separated from one another. Depending on the need in the system, the components often have to be controlled and/or regulated.

If the characteristics of the technical system and/or of the technical process are known and if the influence of disturbance variables on the starting variables of the technical system and/or process can be neglected or if there is a dominant and measurable disturbance variable, so that the effect thereof can be taken into consideration in a control specification, then, preferably, a control is employed. If, for the known characteristics of the technical system and/or of the technical process, several dominant disturbance variables are acting and even only one of them cannot be determined as a function of time, then a regulation has to be employed. The advantage of a regulation in comparison to a control consists in the fact that the regulating difference is counteracted independently of its cause of formation.

With the increase of computer technology, it occurs ever more frequently that individual components in a technical system and/or in a technical process are controlled or regulated through one or more computer processor units. Here, it is not absolutely essential that the computer processor unit(s) is (are) located in the direct environment of the corresponding components. In order to undertake a control or a regulation of the components, the at least one computer processor unit communicates usually with the components, whereby data are also, as a rule, exchanged, it being possible for this to take place, for example, unidirectionally (in one direction) or else bidirectionally (in two directions) as well.

In this process, the computer processor units run under a specific computer operating system environment. In general, a computer operating system represents the link between, on the one hand, the hardware of a computer processor unit and, on the other hand, the user and/or the regulating/control program thereof. An operating system comprises programs that, together with the characteristics of the computer processor unit, constitute the basis of the possible kinds of operation and, in particular, control and monitor the execution of programs.

In the case of a classical operating system, which is suitable for controlling and/or regulating components in a technical system and/or in a technical process, what is involved is a so-called real-time operating system. A computer processor unit that runs on this operating system has, as a rule, one or more interfaces, which can involve, for example, serial and/or parallel interfaces. The use of such known operating systems of controlling and/or regulating aggregates in a technical system has a number of drawbacks, however. Up to now, microprocessors, on which is implemented and run a software that was written in, for example, Assembler or a higher programming language (such as C), have often been employed for controlling and regulating components. The signal processing of the connected components mostly takes place in the immediate vicinity of the microprocessor. The drawback here is that, often, many individual signals have to be conveyed over a wide stretch to the microprocessor. In addition, such systems mostly lack a suitable interface for remote maintenance or remote access. Furthermore, for the known technical systems, it is not possible, as a rule, to drive the individual components through a so-called BUS system. Generally, a BUS system involves a connection architecture that enables a communication of several components with a single computer processor unit. Furthermore, there exists, as a rule, a limited space available for technical systems of this kind.

The present invention is based on the problem of providing a process for controlling and/or regulating at least one component in a technical system and/or in a technical process as well as a technical system, by means of which the drawbacks mentioned can be avoided. In particular, it is intended to make possible, within a technical system and/or a technical process, which can have a large number of components, for its control and/or regulation to be realized in a manner that is as fast as possible, as efficient as possible, and thus as cost-effective as possible.

This problem is solved in accordance with the invention by the process with the features according to the independent patent claim 1 as well as the technical system with the features according to the independent patent claim 10. Further advantages, features, details, aspects, and effects of the invention ensue from the subclaims, the description, and the drawings. Features and details that are described in connection with the process in accordance with the invention also obviously apply in connection with the technical system in accordance with the invention and vice versa.

Provided according to the first aspect of the invention is a process for controlling and/or regulating at least one component in a technical system and/or in a technical process that is characterized by the following steps:
a) bundled in a computer operating environment is a control program for controlling and/or regulating at least one part of at least one component;
b) the control program works together, in the computer operating system environment, with an emulation program, which simulates a computer environment with respect to the control program;
c) the emulation program further simulates an interface to a processing program, which generates, electronically, a suitable connection interface between the control program and the at least one component;
d) an exchange of data takes place unidirectionally or bidirectionally through the connection interface between the control program and the at least one component for the purpose of control and/or regulation.

In accordance with the present process, at least one part of a component within a technical system and/or the technical process is controlled and/or regulated. Here, the invention is not limited to specific kinds of application or to the use of specific technical systems and/or processes.

In general, the process can be employed for controlling and/or regulating technical systems and/or technical processes in process engineering, in aerospace engineering, in industrial control systems, in automobile control and regulation systems, in energy supply, in materials processing, in materials-handling technology, in semiconductor production, in machine construction, and the like.

In order to carry out the process, it is provided for, first of all, that a control program is bundled in a computer operating system environment for controlling and/or regulating at least one part of at least one component.

Here, the invention is not limited to specific types of computer operating system environments. The computer operating system environment can advantageously involve your multitasking and multiuser operating system between workstations and server, which, however, is also portable for personal computers and the like. Especially advantageously, the computer operating system environment can involve the so-called “UNIX” operating system or an operating system based on “LINUX.”

The control program can be initially generated with a suitable program-generation tool and subsequently bundled in the computer operating system environment. The generation of the control program can be conducted in such a way that, for example, the program is generated in an abstract programming language, in which a C code is produced automatically from a graphically programmed program, from which, subsequently, the control program is generated.

The control program works, in the computer operating system environment, together with an emulation program, which simulates a computer environment with respect to the control program. This means that the emulation program influences the control program to believe that it is installed in a computer environment and is running on it.

Furthermore, the emulation program also simulates an interface to a further processing program, which electronically generates a suitable connection interface between the control program and the at least one component. The processing program is likewise bundled in the computer operating system environment and generally serves for data conversion, for data processing, and the like. The processing program has, in particular, the task of generating a connection interface to the interface simulated by the emulation program, through which the components being controlled and/or regulated can be advantageously linked to the control program.

Once this has happened, an exchange of data takes place, at least intermittently, unidirectionally or bidirectionally through the connection interface between the control program and the at least one component for the purpose of control and/or regulation.

By means of the process in accordance with the invention, it is especially simple to control and/or regulate individual components of a technical system and/or of a technical process. It is possible also to join a BUS system to the connection interface, so that, through a single control program, which can be stored, for example, on a single computer processor unit, it is possible to access a large number of components. Furthermore, it is possible, by means of the process in accordance with the invention, for the individual components to be situated at a large separation from the control program. This means that the control program can be implemented, for example, on a central processor unit, while the individual components can be situated at a diversity of sites.

In particular, it can be provided for here that one computer processor unit, on which the computer operating system environment is implemented and on which the individual programs are stored, is designed as a so-called “stand-alone solution.” Through the process in accordance with the invention, it is possible at any time for the control program to communicate with the connection interface and, through it, with the components. To this end, the control program communicates through the processing program and the connection interface with the components being controlled and/or regulated, which are joined to the connection interface.

For example, it can be provided for that the emulation program and the control program involve separate programs, which are stored on different data media and which communicate with each other through suitable interfaces. Advantageously, however, it is provided for that the control program will be or is bundled within the emulation program, this meaning that the control program runs in the emulation program in such a case.

The present invention is not limited to specific embodiments for the connection interface. For example, a connection interface in the form of a USB interface (Universal Serial Bus), a LAN interface (Local Area Network), or a CAN-BUS (Control Area Network) can be generated. Naturally, other types of connection interface are also conceivable and possible.

In an advantageous embodiment, the emulation program can simulate a computer environment with processor and memory storage with respect to the control program. In this way, the emulation program influences the control program to believe that it is running on a conventional computer environment, which, however, actually exists only in the form of software. To this end, it is especially advantageously provided for that the emulation program simulates an interface in the form of a serial interface or a LAN interface with respect to the processing program.

In a further embodiment, data required for the operation of the technical system and/or the technical process can advantageously be generated directly or indirectly in the at least one component, this data being transmitted to the control program and processed or analyzed there. In such a case, there takes place a bidirectional exchange of data between the control program and the individual components. The data transmitted back from the components to the control program can be used, for example, to process and, if need be, to change control routines and/or regulation routines for the individual components. In a further embodiment, it can be provided for that measured values are generated directly or indirectly in the at least one component through at least one sensor element and transmitted to the control program.

Advantageously, it can be provided for that a diagnosis program is provided, which runs under the computer operating system environment and which interacts with the control program and/or the emulation program and/or the processing program, the control program and/or the emulation program and/or the processing program being, in particular, modified through the diagnosis program.

The diagnosis program has, in particular, the task of monitoring the programs linked to it and, if need be, of modifying them or of changing them. Thus, it is possible by means of the diagnosis program, which advantageously runs under the same computer operating system environment as the other programs, to process, modify, and, in the extreme case, even replace the programs linked to it.

As will be described in further detail in the course of the description, the diagnosis program does not necessarily have to be installed on the same computer environment as the other programs. Such a diagnosis program can be employed in a suitable manner for a remote inquiry, a remote control, or the like of the individual programs and/or of the individual components. In such a case, it could, for example, be provided for that a single diagnosis program is employed for several, mutually independent technical systems and/or processes. This diagnosis program can then act through suitable connection possibilities, which will be described in further detail in the further course of the description, on the individual technical systems and/or processes and/or on the programs running in the individual technical systems and/or processes, as needed. This will be described in greater detail in connection with the technical systems in accordance with the invention described below.

The advantages that can be achieved with the aid of the process in accordance with the invention may be summarized, in particular, as follows:

By use of an emulation program, a second hardware environment is simulated on the first hardware environment. The control program runs in the simulated hardware environment. The two hardware environments can be of an identical hardware type, although this is not absolutely essential.

The data acquisition and data output is realized in a decentralized manner by the first hardware environment and then preferably sent via a BUS from and to the actual data acquisition hardware environment (back and forth). To this end, it is especially advantageous to employ a cost-effective USB-BUS. Alternatively, a wireless communication can also be provided, such as, for example, WLAN, Bluetooth, and the like.

Through the software on the operating system, particularly on “LINUX”-based software, on the first hardware environment, there exists the possibility of communicating with the “outside world” in a diversity of ways. For this kind of communication, a TCP/IP-based solution offers itself advantageously.

Advantageously, the process can be employed for controlling and/or regulating at least one component in a technical system designed as a fuel cell system, the invention obviously not being limited to this concrete example.

Fuel cell systems have long been known and have gained substantial importance in recent years. Similarly to batteries, fuel cells produce electrical energy via a chemical path, the individual reactants being supplied continuously and the reaction products being removed continuously.

In a fuel cell, the oxidation and reduction processes proceeding, as a rule, between electrically neutral molecules or atoms are separated spatially through an electrolyte. A fuel cell consists basically of an anode part, to which a fuel is supplied. The fuel cell further has a cathode part, to which an oxidizing agent is supplied. The anode and cathode parts are separated spatially by the electrolyte. Such an electrolyte can involve, for example, a membrane. Such membranes have the capability of allowing ions to pass through, but of holding back gases. The electrons released by the oxidation can be conducted, as electric current, through a consuming device.

As gaseous reaction partner for the fuel cell, it is possible to use, for example, hydrogen as fuel and oxygen as oxidizing agent. If one desires to operate the fuel cell with a readily available or more easily stored fuel, such as, for example, natural gas, methanol, gasoline, diesel, or other hydrocarbons, it is necessary initially to convert the hydrocarbon into a hydrogen-rich gas in a so-called reforming process in a device for the production/processing of a fuel.

A fuel cell system consists, as a rule, of several fuel cells, which, for example, can be formed, in turn, from individual layers. The fuel cells are preferably arranged in succession—for example, stacked on one another in sandwich form. A fuel cell system designed in this way is then referred to as a fuel cell stack.

A fuel cell system can accordingly provide several fuel cell stacks, the fuel cell system then constituting the technical system and the individual fuel cell stacks or the parts thereof constituting the components. Such a fuel cell system can be controlled and/or regulated especially advantageously by means of the process in accordance with the invention.

Provided in accordance with a further aspect of the present invention is a technical system with at least one component and with at least one computer processor unit, on which means for carrying out the process in accordance with the invention, as described above, are implemented. In such a technical system, the individual components can be controlled and/or regulated in an especially simple and elegant manner.

As already discussed further above, the control program can be designed here especially advantageously as a component part of the emulation program.

Advantageously, at least one sensor element for registering operating parameters of the technical system can be provided, the operating parameters then being transmitted from the individual components to the control program.

In a further embodiment, it can also be provided for that a diagnosis program exists, which runs under the same computer operating system environment as the other programs and interacts with the control program and/or the emulation program and/or the processing program. Here, for example, it can be provided for that the diagnosis program and the other programs, such as the control program, the emulation program, the processing program, and the diagnosis program, are implemented on a single computer processor unit.

Alternatively, it is also possible for the diagnosis program to be implemented on a separate computer processor unit. In such a case, the control program, the emulation program, and the processing program can be implemented on a first computer processor unit, while the diagnosis program is implemented on a second, separate computer processor unit. In such a case, the first computer processor unit advantageously has an interface for the diagnosis program.

Insofar as the latter alternative is realized, there exists in the computer operating system environment, in addition to a “control branch,” through which the at least one component of the control program is controlled, preferably also another branch, which, for example, communicates externally through TCP-IP—for example, over the Internet or over an Intranet. In such a case, a Web server can be implemented in the first computer processor unit, through which an interface is realized to the second, separately implemented diagnosis program. In this way, it is possible for the diagnosis program on the second computer processor unit to communicate—for example, over the Internet—with the programs on the first computer processor unit and, if need be, to interact with these. In this way, it is possible in an especially simple manner to enable a remote inquiry, a remote control, or the like of the programs on the first computer processor unit by means of the diagnosis program on the second computer processor unit.

For this purpose, the computer processor units can be connected to one another, at least intermittently, through a line, a wireless connection, or the like. A wireless connection is especially suitable when the communication between the individual programs is to take place through the Internet.

When the technical system involves a fuel cell system, the at least one component can be designed, for example, as a fuel cell, as a part of a fuel cell, or else as a fuel cell stack. In such a case, preferably the individual components of the fuel cell and/or of the fuel cell stack can be controlled and/or regulated through the control program and the process in accordance with the invention described further above. Involved here can be, for example, a corresponding ventilator, a cooling, selected sensors, valves, and the like. Especially advantageously, one component can involve a printed circuit board within or on a fuel cell or a fuel cell stack, it being possible to control and/or regulate the individual components of the fuel cell and/or fuel cell stack by means of the printed circuit board.

Advantageously, the connection interface can be connected to the at least one component through a suitable connection device. Here, the invention is not limited to specific connection devices. However, it is especially advantageous for the connection device to be designed as a BUS system, particularly as a USB-BUS. In such an embodiment, it is possible, in a simple manner, for a whole series of components to be connected to the connection interface and, through it, to establish a connection with the control program in an especially simple manner.

In another embodiment, the control program is further connected—in particular, albeit not absolutely essentially, through the connection interface—through a safety device, particularly a safety line, to the at least one component. Provided to this end is, for example, a direct line, to which each safety function (e.g., emergency cutoff when safety-relevant parameters are exceeded—for example, a temperature or the like) of a component has access. If such a safety switch detects an error, it gives a signal on this line. This common signal then initiates, for example, an emergency cutoff.

The present invention will now be described on the basis of embodiment examples with reference to the accompanying drawings. Shown therein are the following:

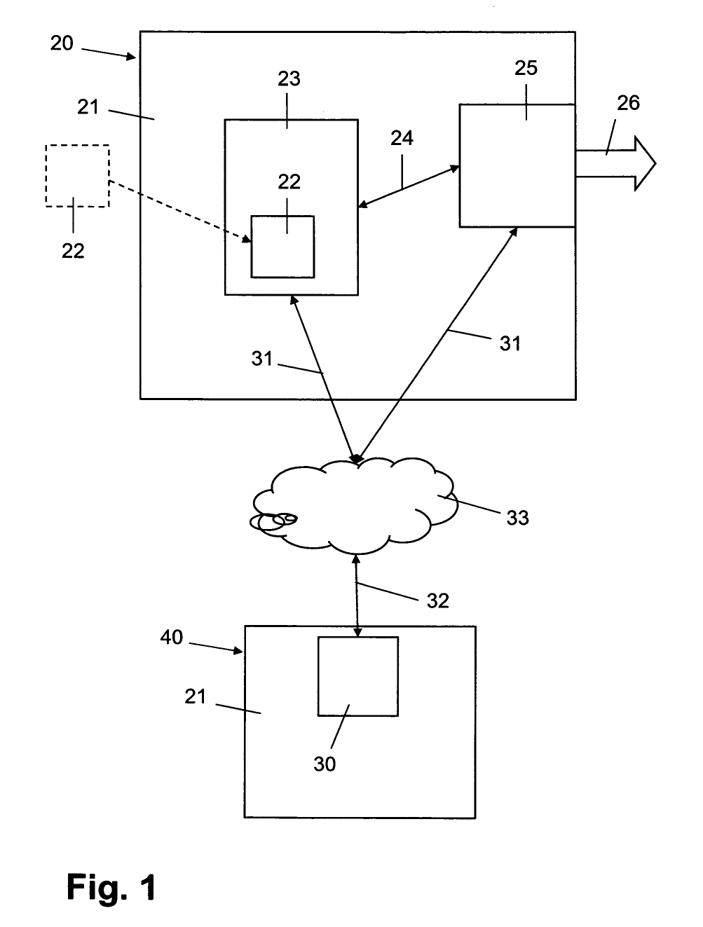

FIG. 1 two computer processor units on which the elements for carrying out the process in accordance with the invention are implemented; and

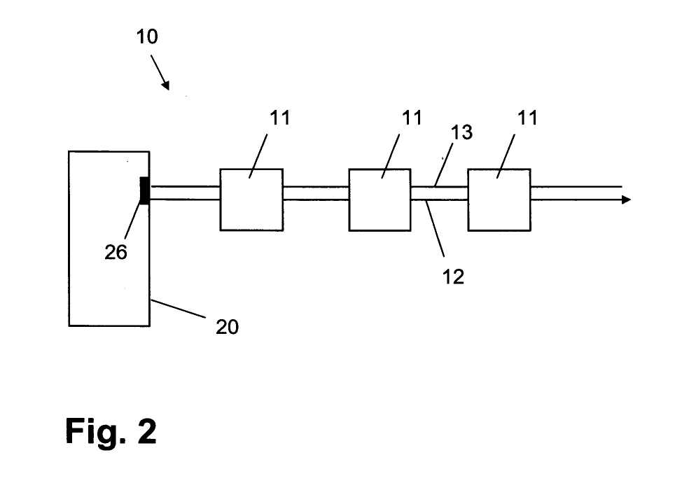

FIG. 2 an embodiment example of a technical system in accordance with the present invention.

Represented in FIG. 2 is a technical system 10—designed, for example, as fuel cell system—which has a number of components 11, which, in the present example, can be designed as fuel cell stacks. Each fuel cell stack is provided with a printed circuit board, by means of which it is connected to a connection device 12. In the present example, the connection device 12 involves a so-called USB-BUS. The individual components 11 of the technical system 10 are to be controlled and/or regulated by means of the connection device 12, the individual components 11 are connected to a first computer processor unit 20. This connection is realized through a suitable connection interface 26. Through the computer processor unit 20. How this can happen in detail is represented in FIG. 1.

The technical system 10 further has a safety device in the form of a safety line 13, through which the individual components 11 are connected, at least intermittently, with the computer processor unit 20. The connection of the safety line 12 with the computer processor unit 20 can occur through the connection interface 26, although this is not absolutely essential. Safety-relevant functions (e.g., emergency cutoff when a temperature, etc. is exceeded) are not realized, as a rule, through software, but rather are embedded in the hardware. In the present example, there exists, to this end, a direct line 12 (one line from each component 11 from, for example, each printed circuit board to the next one, parallel to the line 12), to which each safety function that is embedded in the hardware has access. If such a safety switch detects an error, it gives a signal on this line 13. This common signal then initiates, for example, an emergency cutoff. This means that, regardless of which component 11 triggers the signal, all other components 11 go likewise into a safe state.

The special feature of this safety line 13 is, in addition, that it can also detect, for example, a line break and the computer processor unit 20 can also be joined to this line 13 in order to trigger itself an emergency cutoff or, when an emergency cutoff occurs, to receive this information.

The basis of every regulating and/or control operation of the components 11 is formed by a control program 22, which is generated initially with a suitable control program generation tool. This is represented by the dashed box in FIG. 1. Once the control program 22 has been generated, it is implemented on the first computer processor unit 20. The computer processor unit 20 runs under a computer operating system environment 21, which advantageously involves the so-called “Linux operating system.” The control program 22 is bundled under this computer operating system environment 21. In the present case, the control program 22 is bundled, to this end, in an emulation program 23, which simulates a computer environment with processor and memory storage for the control program 22. The control program 22 runs, in the example, in the emulation program 23.

The emulation program 23 further simulates an interface 24, which can advantageously involve a serial interface, a LAN interface, or the like. Involved here is an interface to a processing program 25, which involves a program for data conversion or data processing and through which a connection interface 26 between the control program 22 and the at least one component 11 is generated to the serial interface 24 (see FIG. 2).

Accordingly, the control program 22 communicates through the interface 24, simulated by the emulation program 23, and the processing program 25 through the connection interface 26, with the components 11, which are joined to the interface 26 through the connection device 12 (FIG. 2).

Accordingly, an exchange of data takes place through the connection interface 26 between the control program 22 and the components 11 for the purpose of control and/or regulation, which, depending on the case of application, can be unidirectional or bidirectional. In the latter case, measured values can be sent from the components 11 to the control program 22 in the emulation program 23 and further processed there.

Finally, the computer processor unit 20 and/or the programs 22, 23, 25 bundled in the computer operating system environment 21 is and/or are linked through suitable interfaces 31 with a diagnosis program 20, which is implemented on a computer processor unit 40 that is separate with respect to the computer processor unit 20. Here, the computer processor unit 40 is intended to provide the same computer operating system environment 21 as does the computer processor unit 20, the diagnosis program 30 being bundled in this computer operating system environment. Through the diagnosis program 30, it should be possible, by means of a remote inquiry, a remote control, or the like, to act on the programs 22, 23, 25 bundled in the computer processor unit 20. In particular, it should be possible with the diagnosis program 30 to work on the control program 22 in the emulation program 23—for example, to modify it or, in the extreme case, even to replace it.

To this end, the two computer processor units 20, 40 are connected or can be connected to each other, at least intermittently, by means of a wireless connection 32—in the present case, over the Internet 33. Through the wireless connection 31 and the corresponding interfaces 31, the diagnosis program 30 can now communicate with the programs 22, 23, 25 in the first computer processor unit 20.

Such an embodiment has the advantage that individual technical systems 10 that are separated spatially from one another can be addressed through a single central diagnosis program, which can be implemented in, for example, a central processor unit, and, if need be, can be worked on or modified. This allows an especially simple and nonetheless effective monitoring also of such technical systems 10 that are situated spatially far apart from one another.

Reference List

10 Technical system (fuel cell system)
11 Components of the technical system
12 Connection device (USB-BUS)
13 Safety device (safety line)
20 First computer processor unit
21 Computer operating system environment
22 Control program
23 Emulation program
24 Interface
Processing program
26 Connection interface
30 Diagnosis program
31 Interface
32 Wireless connection
33 Internet
40 Second computer processor unit

1. A process for controlling and/or regulating at least one component in a technical system and/or in a technical process,
characterized by the following steps:
a) bundled in a computer operating environment is a control program for controlling and/or regulating at least one part of at least one component;
b) the control program works together, in the computer operating system environment, with an emulation program, which simulates a computer environment with respect to the control program;
c) the emulation program further simulates an interface to a processing program, which generates, electronically, a suitable connection interface between the control program and the at least one component;
d) an exchange of data takes place unidirectionally or bidirectionally by means of the connection interface between the control program and the at least one component for the purpose of control and/or regulation.

2. The process according to claim 1, further characterized in that the control program is or will be bundled within the emulation program.

3. The process according to claim 1, further characterized in that a connection interface is generated by the processing program in the form of a USB interface, a LAN interface, or a CAN-BUS.

4. The process according to claim 1, further characterized in that the emulation program simulates a computer environment with processor and memory storage with respect to the control program.

5. The process according to claim 1, further characterized in that the emulation program simulates a serial interface or a LAN interface to the processing program.

6. The process according to claim 1, further characterized in that, in the at least one component, data required directly or indirectly for the operation of the technical system and/or the technical process are generated and are transmitted to the control program and processed or analyzed there.

7. The process according to claim 6, further characterized in that, in the at least one component, measured values are generated directly or indirectly through at least one sensor element and transmitted to the control program.

8. The process according to claim 1, further characterized in that a diagnosis program is provided, which runs under the computer operating system environment and interacts with the control program and/or the emulation program and/or the processing program, wherein the control program and/or the emulation program and/or the processing program, in particular, is modified by means of the diagnosis program.

9. The process according to claim 1 for controlling and/or regulating at least one component in a fuel cell system.

10. A technical system with at least one component and with at least one computer processor unit, on which means for carrying out the process according to claim 1 is implemented.

11. The technical system according to claim 10, further characterized in that the control program is designed as a component part of the emulation program.

12. The technical system according to claim 10, further characterized in that at least one sensor element is provided for registering operating parameters of the technical system.

13. The technical system according to claim 10, further characterized in that a diagnosis program is provided, which runs under the computer operating system environment and which interacts with the control program and/or the emulation program and/or the processing program.

14. The technical system according to claim 10, further characterized in that the computer processor unit has an interface for the diagnosis program and that the diagnosis program is implemented on a separate computer processor unit.

15. The technical system according to claim 14, further characterized in that the computer processor units are connected to each other, at least intermittently, by means of a line or a wireless connection.

16. The technical system according to claim 10, further characterized in that it is designed as fuel cell system and that the at least one component is designed as a fuel cell or as a part of a fuel cell or as a fuel cell stack.

17. The technical system according to claim 16, further characterized in that the component is designed as a printed circuit board within or on a fuel cell or a fuel cell stack.

18. The technical system according to claim 10, further characterized in that the connection interface is connected to the at least one component by means of a connection device.

19. The technical system according to claim 18, further characterized in that the connection device is designed as a bus system, in particular as a USB-BUS.

20. The technical system according to claim 10, further characterized in that the control program, the emulation program, the processing program, and the diagnosis program are implemented on a single computer processor unit.

21. The technical system according to claim 14, further characterized in that the control program, the emulation program, and the processing program are implemented on a first computer processor unit, that the first computer processor unit has an interface for the diagnosis program, and that the diagnosis program is implemented on a second, separate computer processor unit.

22. The technical system according to any one of claims 10 to 21, further characterized in that the control program is connected, particularly by means of the connection interface through a safety device, particularly a safety line, to the at least one component.
